(19) United States
(12) Patent Application Publication
(10) Pub. No.: US 2022/0001420 A1
(43) Pub. Date: Jan. 6, 2022

(54) SPORTS EQUIPMENT WITH PATTERN CREATED IN MAGNETIC PAINT

(71) Applicant: TRUE TEMPER SPORTS, INC., Memphis, TN (US)

(72) Inventors: Donald Collins BROWN, Jr., San Diego, CA (US); Jose MORENO, San Diego, CA (US)

(73) Assignee: TRUE TEMPER SPORTS, INC., Memphis, TN (US)

(21) Appl. No.: 17/428,775

(22) PCT Filed: Jan. 29, 2020
(86) PCT No.: PCT/US2020/015652

§ 371 Date: Aug. 5, 2021

Related U.S. Application Data
(60) Provisional application No. 62/805,512, filed on Feb. 14, 2019.

(51) Int. Cl. B05D 7/24; A63B 53/10; A63B 59/50; A63B 59/70; C09D 11/52

(52) U.S. Cl. CPC B05D 7/24; A63B 53/10; A63B 2102/18; A63B 59/70; C09D 11/52; A63B 59/50

(57) ABSTRACT

A piece of sports equipment includes: a surface; and base paint including magnetic particles, the base paint being located on the surface of the piece of sports equipment, the magnetic particles being arranged based on a predetermined design after being subjected to magnetic field generated by one or more magnets. A method of manufacturing a piece of sports equipment includes: obtaining an object including one or more magnets arranged in a predetermined design; applying a base paint including magnetic particles to an exterior surface of the piece of sports equipment; while the base paint is fluid, positioning the piece of sports equipment within a magnetic field of the one or more magnets; and maintaining the positioning of the piece of sports equipment for at least a predetermined period, thereby allowing the magnetic particles in the base paint to arrange based on the predetermined design of the one or more magnets.

### CROSS-REFERENCE TO RELATED APPLICATIONS

The present disclosure is a PCT International Application, which claims the benefit of U.S. Provisional Application No. 62/805,512, filed on Feb. 14, 2019. The entire disclosure of the application referenced above is incorporated herein by reference.

### FIELD

The present disclosure relates to shafts of golf clubs and more particularly to sports equipment with magnetic paint and methods of creating designs in magnetic paint of sports equipment.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Golf shafts may have base paint that is a solid color.

Different sports use different types of equipment. For example, golf clubs and balls are used in the sport of golf, lacrosse sticks and balls are used in the sport of lacrosse, hockey sticks and pucks are used in the sport of hockey, baseball bats and balls are used in the sport of baseball, etc. In golf, golf clubs are used strike golf balls. In lacrosse, lacrosse sticks are used to pass, shoot, and carry lacrosse balls. In baseball, baseball bats are used to contact baseballs. In hockey, hockey sticks are used to pass, deflect, and shoot hockey pucks.

### SUMMARY

In a feature, a piece of sports equipment includes: a surface; and base paint including magnetic particles, the base paint being located on the surface of the piece of sports equipment, the magnetic particles being arranged based on a predetermined design after being subjected to magnetic field generated by one or more magnets.

In further features, the piece of sports equipment is a golf club shaft.

In further features, the piece of sports equipment is a hockey stick, and the surface is a surface of a handle portion of the hockey stick.

In further features, the piece of sports equipment is a hockey stick, and the surface is a surface of a blade portion of the hockey stick.

In further features, the piece of sports equipment is a lacrosse stick and the surface is a surface of a handle portion of the lacrosse stick.

In further features, the piece of sports equipment is a baseball bat.

In further features, a second coat of paint is applied over the base paint.

In a feature, a method of manufacturing a piece of sports equipment includes: obtaining an object including one or more magnets arranged in a predetermined design; applying a base paint including magnetic particles to an exterior surface of the piece of sports equipment; while the base paint is fluid, positioning the piece of sports equipment within a magnetic field of the one or more magnets; and maintaining the positioning of the piece of sports equipment for at least a predetermined period, thereby allowing the magnetic particles in the base paint to arrange based on the predetermined design of the one or more magnets.

In further features the method further includes, after the maintaining the positioning of the piece of sports equipment for at least the predetermined period, curing the base paint.

In further features the method further includes, after the maintaining the positioning of the piece of sports equipment for at least the predetermined period, applying a second coat of paint over the base paint.

In further features the positioning the piece of sports equipment includes positioning the piece of sports equipment within a hollow interior of the object, wherein the one or more magnets are arranged on an interior surface of the object.

In further features the positioning the piece of sports equipment includes positioning the object within a hollow interior of the piece of sports equipment, wherein the one or more magnets are arranged on an exterior surface of the object.

In further features the positioning the piece of sports equipment includes positioning the object within a hollow interior of the piece of sports equipment, wherein the one or more magnets are arranged within the object.

In further features the object is made of a non-magnetic material.

In further features the one or more magnets include one or more rare earth magnets.

In further features the one or more magnets include one or more neodymium magnets.

In further features the positioning the piece of sports equipment includes positioning the piece of sports equipment adjacent to the object, wherein the one or more magnets are arranged on a surface of the object.

In further features the piece of sports equipment is a golf shaft.

In further features the piece of sports equipment is one of a hockey stick, a lacrosse stick, and a baseball bat.

In further features the magnetic particles include ferromagnetic particles.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 includes an example illustration of a base paint application system including a shaft painting apparatus;

FIG. 2 includes an example illustration of a paint applicator with a circular aperture;

FIG. 3 includes an example illustration of a golf club shaft inserted through an aperture of a paint applicator;

FIG. 4 includes an example illustration of an actuator arm being vertically lowered to flow base paint toward a paint applicator;

FIGS. 5A, 5B, 6A, and 6B are example illustrations of a rod (object) and a golf club shaft;

FIG. 7 includes an example illustration of an object including a plurality of magnets that are equally spaced;

FIG. 8 includes a flowchart depicting an example method of creating a design in magnetic base paint on a tubular sports member, such as a golf (club) shaft;

FIG. 9 includes an example illustration including a hockey stick;

FIGS. 10 and 11 include example illustrations of a design formed on a blade portion of a hockey stick;

FIGS. 12 and 13 include example illustrations of a design formed on a handle portion of a hockey stick;

FIG. 14 includes an example illustration of a design formed on a handle portion of a lacrosse stick;

FIG. 15 includes an example illustration of a design formed on a baseball bat; and

FIGS. 16 and 17 include perspective views of portions of pieces of sports equipment and objects used to create designs on the sports equipment.

In the drawings, reference numbers may be reused to identify similar and/or identical elements.

### DETAILED DESCRIPTION

Designs may be applied to a golf shaft on top of a layer of base paint applied to the golf shaft. For example, designs may be painted onto the base paint, adhered to the base paint (e.g., in the example of a sticker), etc.

The ability to create a design in paint applied to the golf shaft using magnetic particles in the paint provides a cosmetic that will help differentiate a product in the market place. The design may also help achieve one or more target has target structural (e.g., torsional, bending, etc.) characteristics. The present disclosure describes golf shafts (e.g., graphite, steel, or hybrid graphite and steel) and other types of sports equipment with designs formed via magnetic particles of base paint applied to the golf shaft and methods of manufacturing the same.

An example method includes creating designs in the magnetic base paint by inserting a rod having one or more magnets arranged in the shape of a design into the golf shaft. Another example method includes creating designs in the magnetic base paint by positioning one or more magnets arranged in the shape of the design radially outwardly of the golf shaft. Once a design has been created in the magnetic base paint, a coat of translucent or transparent paint can be applied, for example, to increase a depth of color.

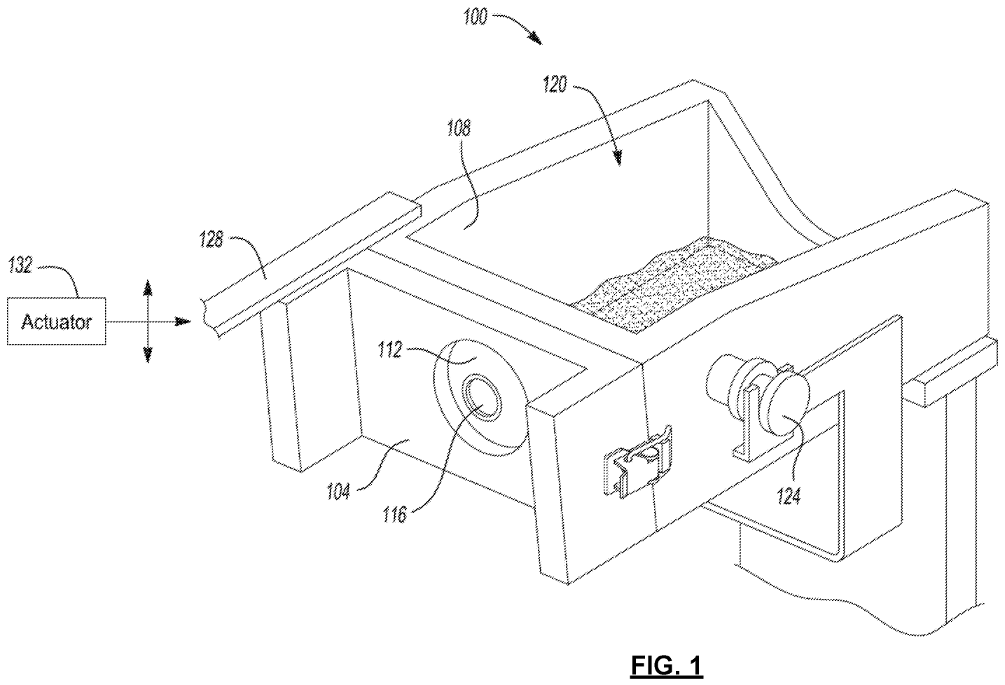

FIG. 1 includes an example illustration of a base paint application system including a shaft painting apparatus 100. The shaft painting apparatus 100 may be used to apply one or more layers of base paint to golf club shafts, such as graphite golf club shafts, steel golf club shafts, and hybrid steel and graphite golf club shafts. While the example a golf club shaft is provided, the following is also applicable to other types of tubular sports equipment, such as hockey sticks, lacrosse sticks, and baseball bats.

The shaft painting apparatus 100 may include a first portion 104 and a second portion 108. A paint applicator 112 (e.g., a squeegee or a sponge) is sandwiched between the first portion 104 and the second portion 108 and includes an aperture 116 within apertures in the first and second portions 104 and 108. The aperture 116 may be circular. Alternatively, the aperture 116 may be non-circular, such as triangular, square, pentagonal, hexagonal, heptagonal, octagonal, etc. The aperture 116 may have one or more notches formed in the outer edge of the aperture 116 in various implementations.

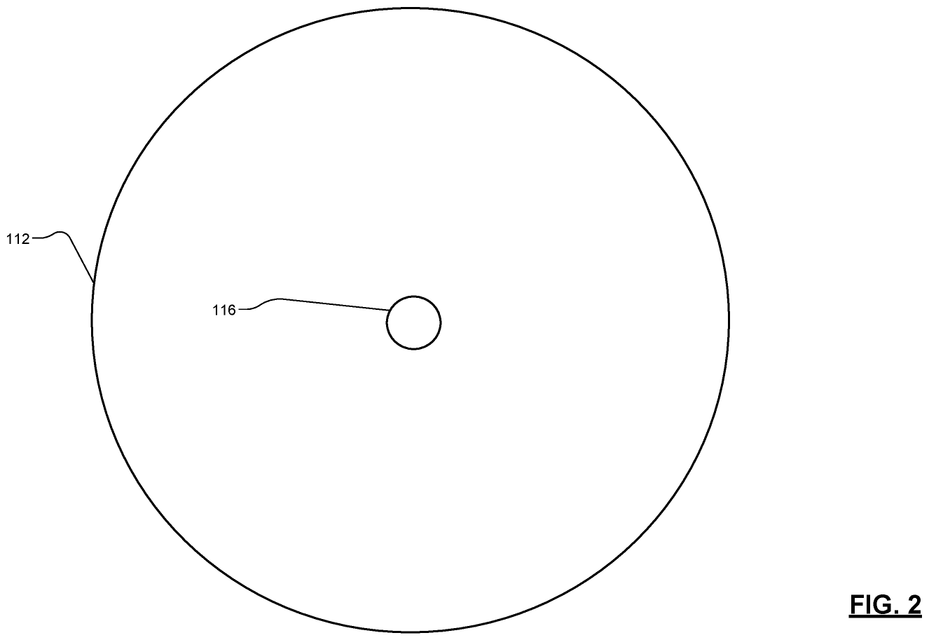

FIG. 2 includes an example illustration of the paint applicator 112 where the aperture 116 is circular. The paint applicator 112 may be made of, for example, rubber or another suitable pliable material. The diameter of the aperture 116 may be smaller than a smallest diameter of golf shafts to be painted using the shaft painting apparatus 100. Golf shafts may be tapered or have different diameters from one end to the other. The aperture 116 may have the same shape (e.g., circular, rectangular, hexagonal, octagonal, etc.) as the tubular sports equipment that is drawn through the aperture 116.

Referring back to FIG. 1, base paint is filled into a recess 120 in the second portion 108. The shaft painting apparatus 100 may be rotatable about an axis 124. An actuator arm 128 may be mounted to the shaft painting apparatus 100 and may be moved vertically upwardly and downwardly to rotate the shaft painting apparatus 100 about the axis 124.

When the actuator arm 128 is lowered vertically, base paint within the recess 120 may flow toward the paint applicator 112. When the actuator arm 128 is raised vertically, base paint within the recess 120 may flow away from the paint applicator 112. A stop may be implemented to provide an upper most position for the actuator arm 128 (a rest position of the shaft painting apparatus 100) where the base paint flows away from the paint applicator 112.

An actuator 132 actuates the actuator arm 128 upwardly or downwardly. The actuator 132 may be, for example, a human or a robot. While the example of applying the paint using the shaft painting apparatus 100 is provided, paint may additionally or alternatively be applied to the tubular sports equipment in another suitable manner, such as by spraying using a spray gun.

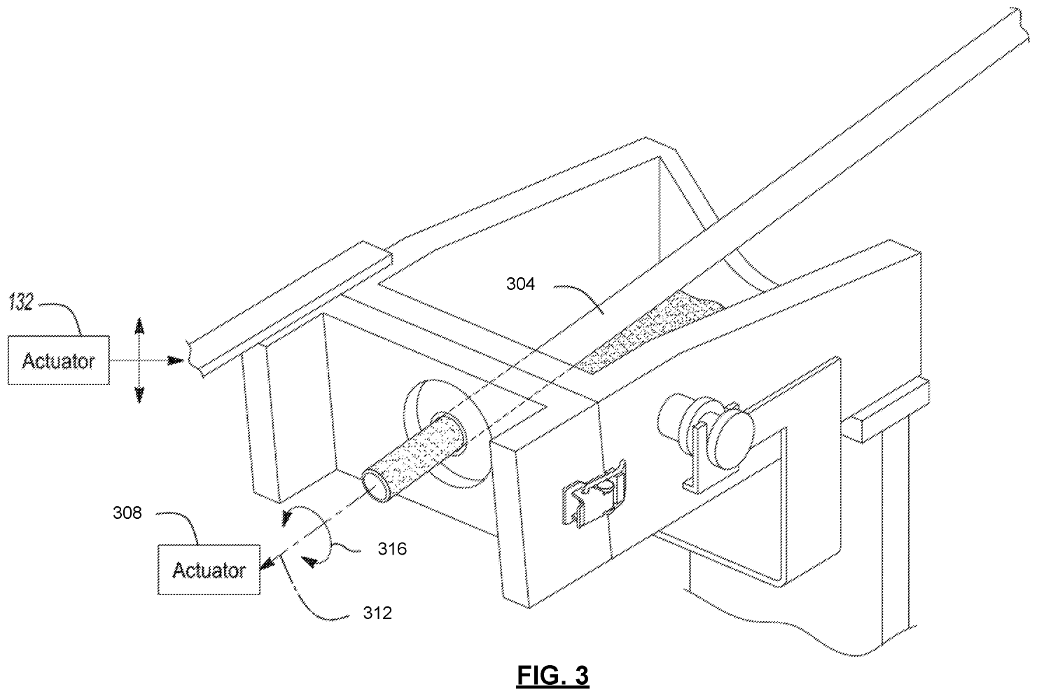

FIG. 3 includes an example illustration of a golf club shaft 304 inserted through the aperture 116 of the paint applicator 112. For example, the smaller diameter end of the golf shaft 304 may be inserted through the aperture 116 in the paint applicator 112. While the example of a graphite golf shaft is provided, the present application is also applicable to steel golf shafts, hybrid steel and graphite golf shafts, and other types of golf shafts. The golf shaft 304 may be inserted through the aperture 116 when the shaft painting apparatus 100 is in the rest position.

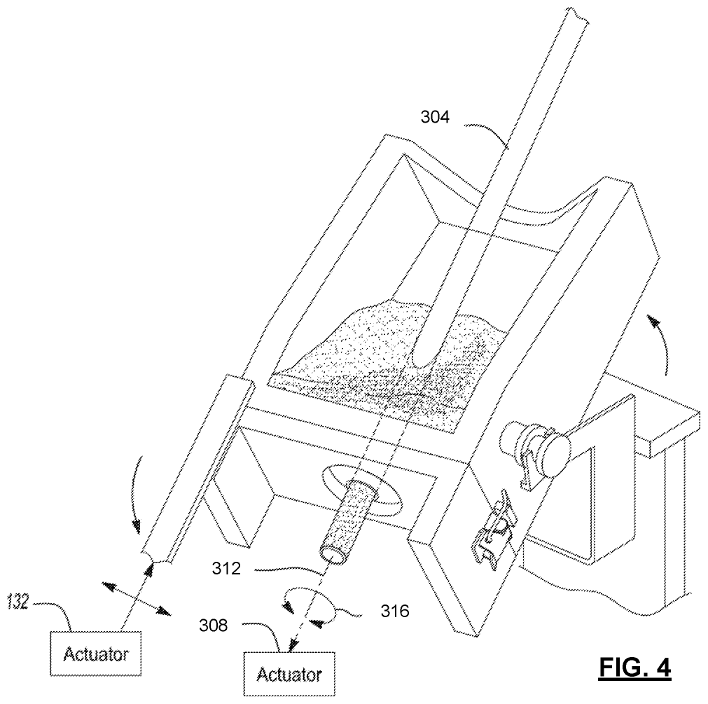

Once the golf shaft 304 is inserted through the aperture 116, the actuator 132 lowers the actuator arm 128, thus causing the base paint within the recess 120 to flow toward the paint applicator 112. FIG. 4 includes an example illustration of the actuator arm 128 being vertically lowered (relative to its position in the rest position). As shown, the base paint within the recess 120 flows (by gravitational force) toward the paint applicator 112.

While the base paint is present on the paint applicator 112, an actuator 308 axially pulls the golf shaft 304 through the aperture 116. The axial pulling of the golf shaft 304 is illustrated by arrow 312. The actuator 308 may be a human or a robot. The actuator 308 may be the same as the actuator 132 in some instances, such as when a human applies the base paint to golf shafts.

The actuator 308 may axially pull the golf shaft 304 through the aperture 116 to create a uniform layer of base paint along the length of the golf shaft 304. The actuator 308 may rotate the golf shaft 304 about the axis of the golf shaft 304 concurrently with pulling the golf shaft 304 through the aperture 116 or alternately with pulling the golf shaft 304 through the aperture. The rotation of the golf shaft 304 is illustrated by arrow 316.

While the example of applying the base paint to the golf shaft 304 using the shaft painting apparatus 100 is provided, the base paint may be applied to the golf shaft 304 in another suitable manner, such as via spraying using a paint gun.

One or more coats of base paint may be applied to a golf shaft. Each coat of the base paint may be cured prior to the application of a next layer of the base paint to the golf shaft. Once the base paint has been applied (and is dry), one or more coats of transparent or translucent paint can be applied over the base paint. Transparent or translucent paint may increase a depth of the paint on a golf shaft.

The base paint includes magnetic particles, such as ferromagnetic particles. Before the outermost layer of the base paint is cured/dried (i.e., while the base paint is still fluid), one or more magnets in the shape of one or more designs are positioned near the golf shaft. The magnet(s) draw the magnetic particles toward the magnets to create the design in the magnetic particles of the base paint.

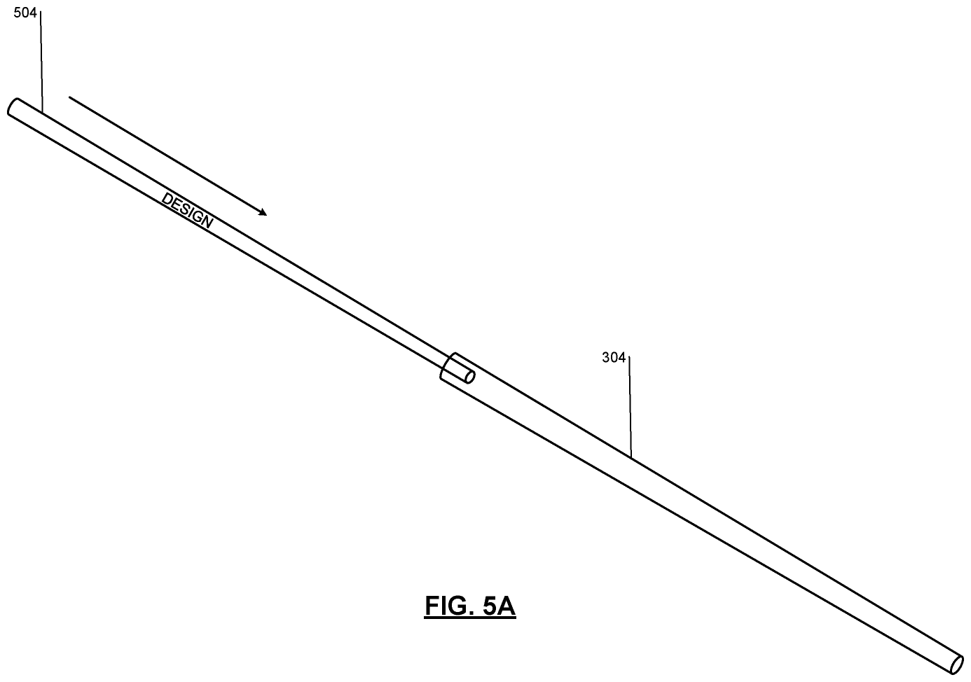

FIG. 5A includes an example illustration of the golf shaft 304 when coated with a layer of the base paint including magnetic particles while the base paint is still fluid. A rod (or another type of tubular member) 504 includes a design formed in magnets, for example, on an exterior surface of the rod 504. In this example, the word “DESIGN” is formed in magnets on the exterior surface of the rod 504. The magnets may be, for example, adhered to the exterior surface of the rod 504. In various implementations, the design of magnets may instead be located on an interior surface of the rod 504 and the golf shaft 304 may be inserted within the rod, such as illustrated in FIG. 5B. The magnets may include, for example, neodymium magnets or another suitable type of magnet. In various implementations, only one magnet shaped in the design may be used. While the example of the word “DESIGN” is provided, the magnet(s) may be arranged to form other designs including other words, letters, logos (trademarked or non-trademarked), images, etc. In various implementations, a cutting device (e.g., a computer numerical control (CNC) cutting machine, such as a CNC router) may cut one or more magnets in response to user input indicative of a design for the magnet(s).

The golf shaft 304 includes a hollow interior. In the example of FIG. 5A, the rod 504 is inserted into the interior of the golf shaft 304 and maintained in position for a predetermined period. In the example of FIG. 5B, the rod 504 includes a hollow interior. The golf shaft 304 is inserted into the interior of the rod 504 and maintained in position for a predetermined period.

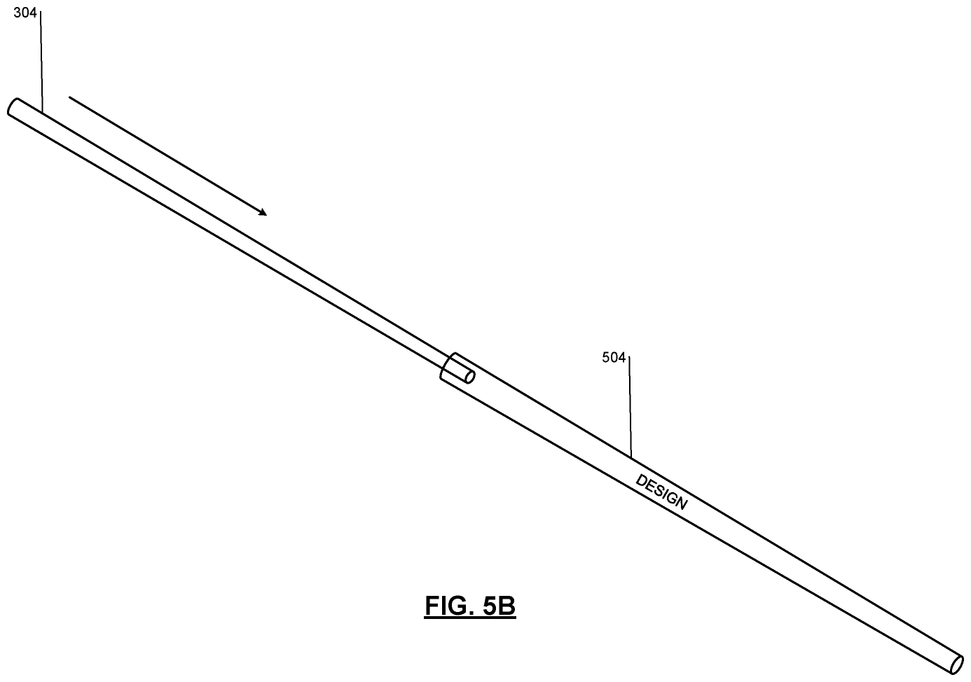

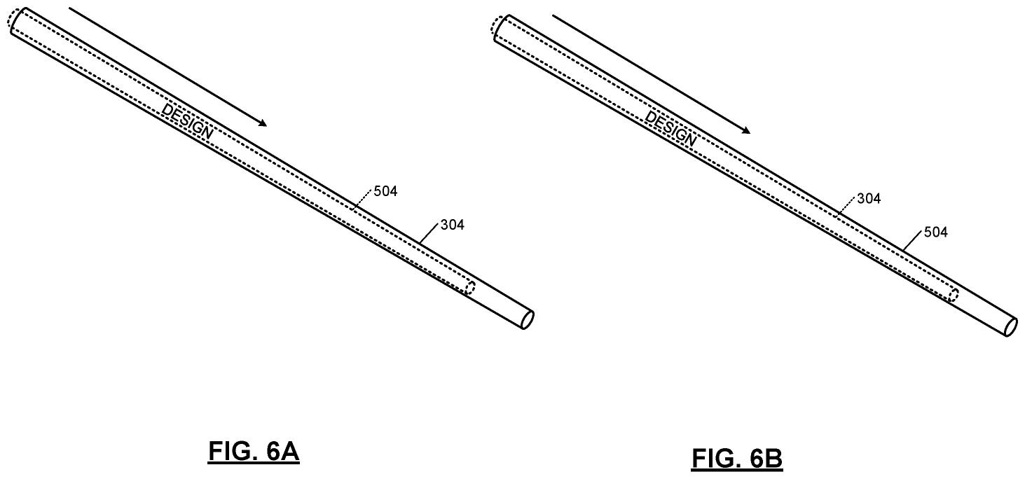

FIG. 6A includes an example illustration of the rod 504 inserted into the golf shaft 304. FIG. 6B includes an example illustration of the golf shaft 304 inserted into the rod 504. The magnetic field of the magnets draws the magnetic particles in the (fluid) base paint toward the magnets, thus creating the design in the base paint on the golf shaft 304. After at least the predetermined period has passed, the rod 504 can be removed from the golf shaft 304 and the base paint can be cured/dried. The magnetic particles remain in place after the rod 504 is removed.

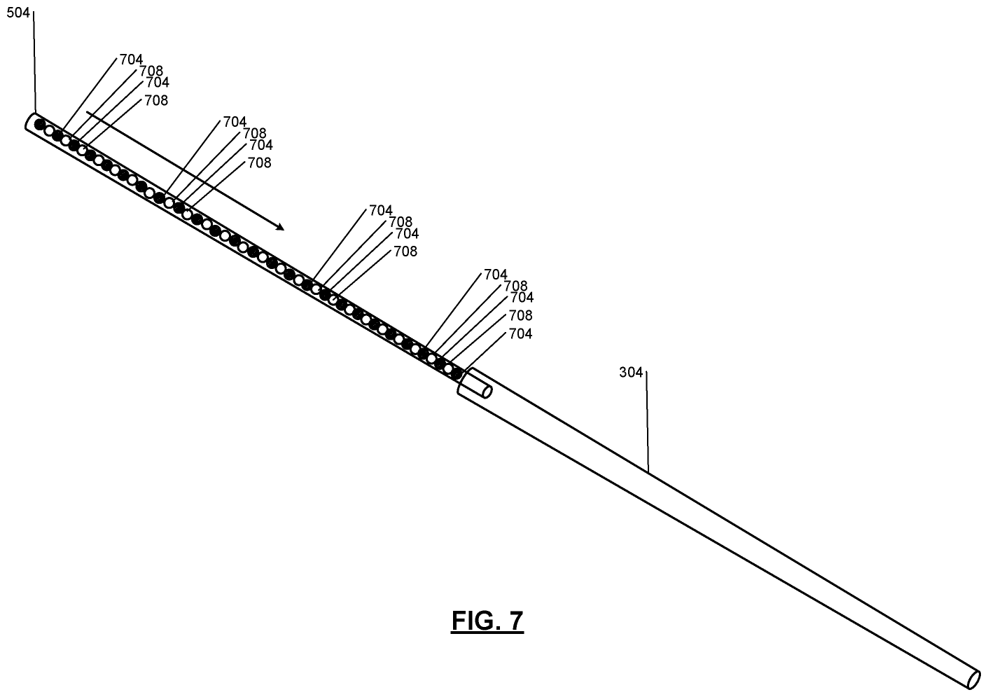

In various implementations, the rod 504 may include a hollow interior and magnets may be arranged within the interior of the rod 504 to create a design in the base paint. The rod 504 may be made of, for example, a transparent plastic or another suitable type of material. For example, magnets 704 of the same shape may be equally spaced (e.g., via non-magnets 708) within the rod 504, such as in the example of FIG. 7. The spacing of the magnets 704 within the rod 504 may be equal or non-equal. As stated above, while the example of the golf shaft 304 is provided, the present application is also applicable to creating designs in base paint including magnetic particles on other types of sports equipment, such as hockey sticks, lacrosse sticks, and baseball bats. Also, while the example of the rod 504 is provided, magnets may alternatively be placed on a flat surface (e.g., face) of an object, and the object may be positioned sufficiently near the tubular sports member as to allow the magnetic field of the magnets to impart movement of the magnetic particles in the base paint on the tubular sports member.

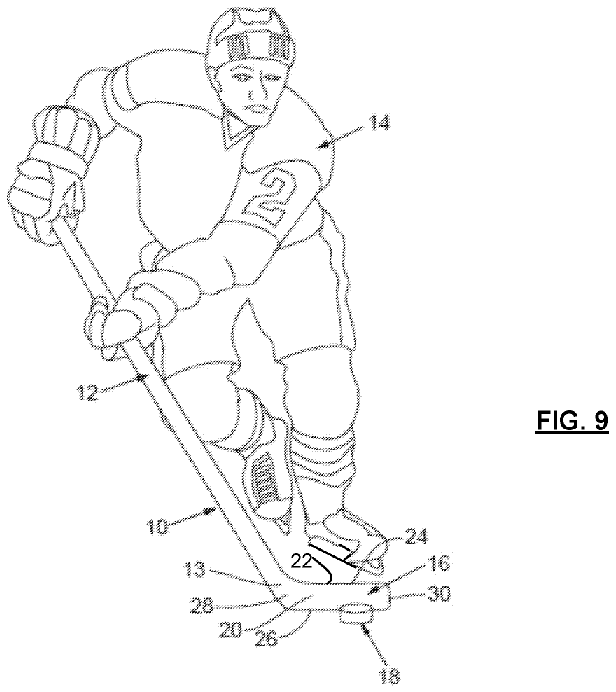

FIG. 9 includes an example illustration including a hockey stick 10. The hockey stick 10 includes a handle portion 12 (i.e., shaft), which a player 14 holds, and a blade portion 16 (i.e., blade), which is used for controlling a hockey puck 18 or a ball. The hockey stick 10 can be adapted for any position on a hockey team, including that of a goalie. In other words, the hockey stick 10 may be a goalkeeper hockey stick or a hockey stick configured to be used by other positions. While the example of an ice hockey stick will be provided, the present application is also applicable field hockey sticks, roller hockey sticks, and other types of sports equipment.

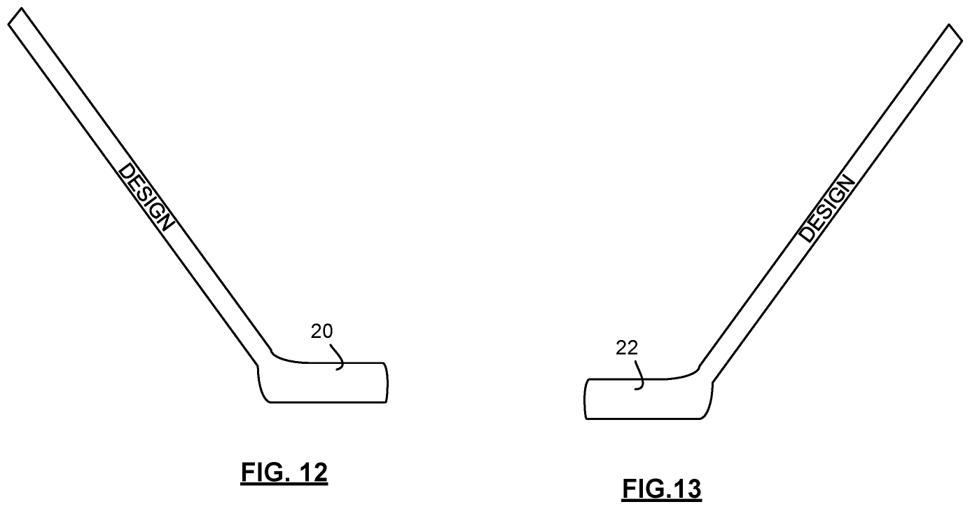

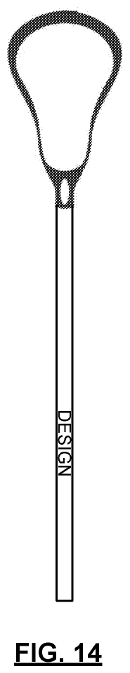

The handle portion 12 can be elongated and longitudinally straight. In some embodiments, the handle portion 12 can include a hollow core that is embedded and wrapped within a covering (e.g., composite material with carbon fibers). The design can be created in base paint including magnetic particles on the handle portion 12. FIGS. 12 and 13 include example illustrations of the design “DESIGN” being formed on the handle portion 12 using magnets, as described above. FIG. 14 includes an example illustration of the design “DESIGN” being formed on the handle portion of a lacrosse stick using magnets, as described above. One or more different designs may be created on any one or more sides of the handle portion of a hockey stick or a lacrosse stick using magnets, as described above.

Referring back to FIG. 9, the handle portion 12 includes a blade connecting end 13. The blade portion 16 is fixed to the blade connecting end 13 of the handle portion 12. The blade portion 16 can be fixed to the blade connecting end 13 in any suitable manner. The handle portion 12 and the blade portion 16 can be manufactured separately and subsequently attached together. Alternatively, the handle portion 12 and the blade portion 16 may be manufactured together.

The blade portion 16 generally includes a front face 20, which can be used for receiving and moving the hockey puck 18 (e.g., passing, shooting, etc.), and a rear face 22, which can also be used for receiving and moving the hockey puck 18. The blade portion 16 also includes a first end 28 that is connected to the blade connecting end 13 of the handle portion 12. The blade portion 16 also includes a second end 30 that is opposite to the first end 28.

The blade portion 16 also includes an upper edge 24 and a lower edge 26 that is opposite the upper edge 24. The upper edge 24 is typically spaced away from a playing surface (e.g., ice). The lower edge 26 may contact the playing surface.

Both the upper and lower edges 24 and 26 extend between the first and second ends 28 and 30 of the blade portion 16. The upper and lower edges 24 and 26 and the front and rear faces 20 and 22 can have a curvature between the first and second ends 28 and 30 such that the front face 20 is concave while the rear face 22 is convex.

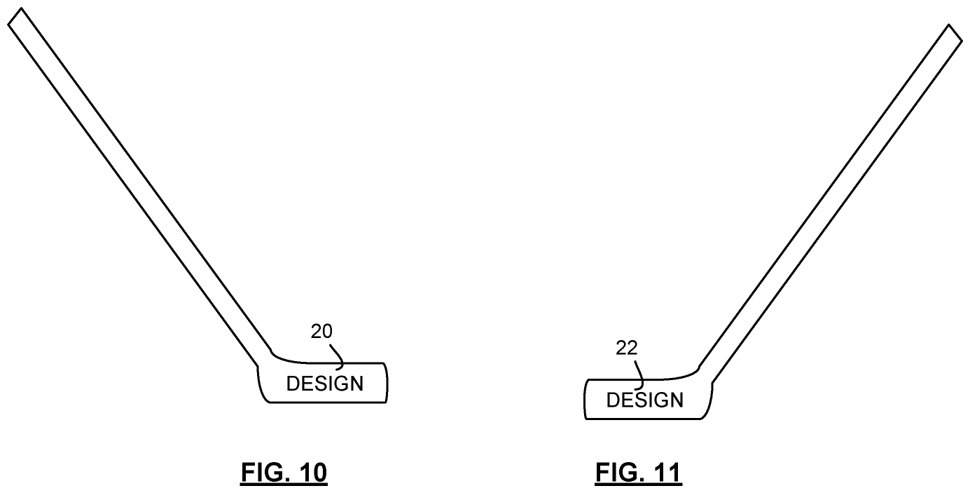

The blade portion 16 includes a covering that is wrapped around one or more core members. The covering includes one or more layers of composite material, similar to the golf club shaft described above. The design in the base paint including magnetic particles can be formed on the blade portion 16. The design can be located on the front face 20, the rear face 22, or both of the front and rear faces 20 and 22. FIGS. 10 and 11 include example illustrations of the design “DESIGN” being formed on the blade portion 16 using magnets, as described above.

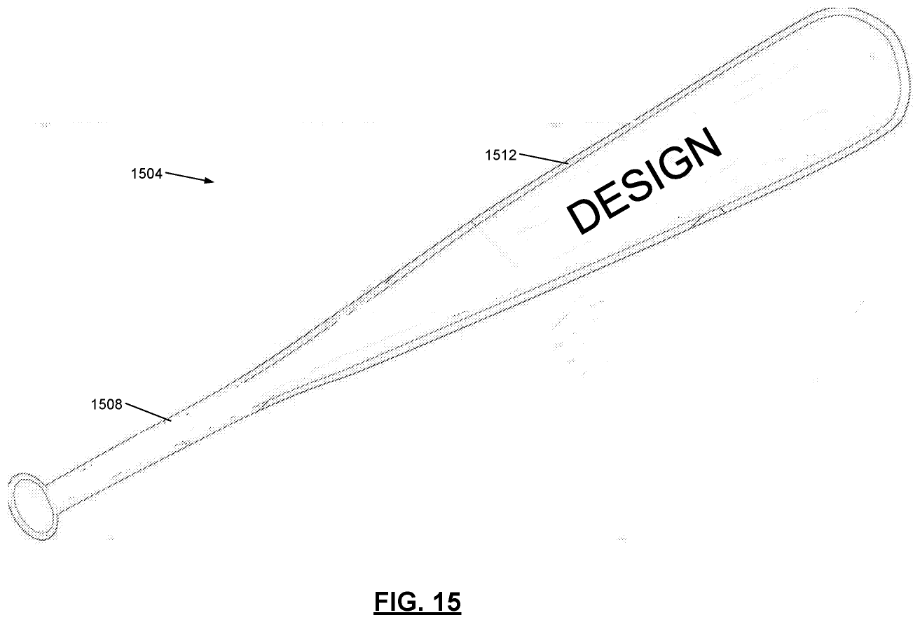

FIG. 15 includes an example illustration including a baseball bat 1504 having the design “DESIGN” formed using magnets, as described above. The baseball bat 1504 includes a handle portion 1508, which a player holds, and a head or barrel portion 1512, which is used to bat/contact a ball. The handle portion 1508 and the barrel portion 1512 may be separate pieces that are integrated together or may be a single monolithic piece. While the example of the design being formed in the base paint on the barrel portion 1612 is shown in FIG. 15, additionally or alternatively one or more designs may be formed in base paint on the handle portion 1508 using magnets.

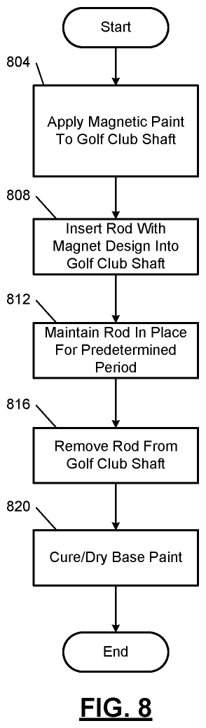

FIG. 8 includes a flowchart depicting an example method of creating a design in base paint on a tubular sports member, such as a golf (club) shaft. Control begins with 804 where a coat of the base paint (including magnetic particles) is applied to the tubular sports member, such as the golf shaft. A portion of the golf shaft at the larger diameter end of the golf shaft may extend out from the paint applicator 112 and not be painted. A grip is later applied at the larger diameter end of the golf shaft.

At 808, while the base paint is still fluid, the tubular sports member is positioned within the magnetic field of the magnets such that the magnets in the shape of the design move the magnetic particles in the base paint and form the design in the base paint. For example, tubular sports member may be inserted into the rod or the rod may be inserted within the tubular sports member. Alternatively, the tubular sports member may be position near an object having magnets located on a surface of the object.

At 812, the tubular sports member is maintained in place for a predetermined period. This allows the magnet(s) to draw the magnetic particles in the base paint toward the magnet(s) to create the design of the magnets in the base paint. The predetermined period may be selected/set to ensure creation of the design in the base paint using magnet(s), as described above.

At 816, the tubular sports member is removed from the magnetic field. The magnetic particles remain in place despite the removal of the tubular sports member from the magnetic field of the tubular sports member. Thus, the design created by the magnets in the base paint remains after the removal of the tubular sports member from the magnetic field. At 820, the base paint is cured/dried. This fixes the design and the base paint in place on the tubular sports member. Optionally one or more coats of transparent or translucent paint may be applied to the tubular sports member as a top coat. Once the paint has dried on the golf shaft, a golf club head can be attached to the smaller diameter end of the golf shaft, and a grip can be attached to the larger diameter end of the golf shaft.

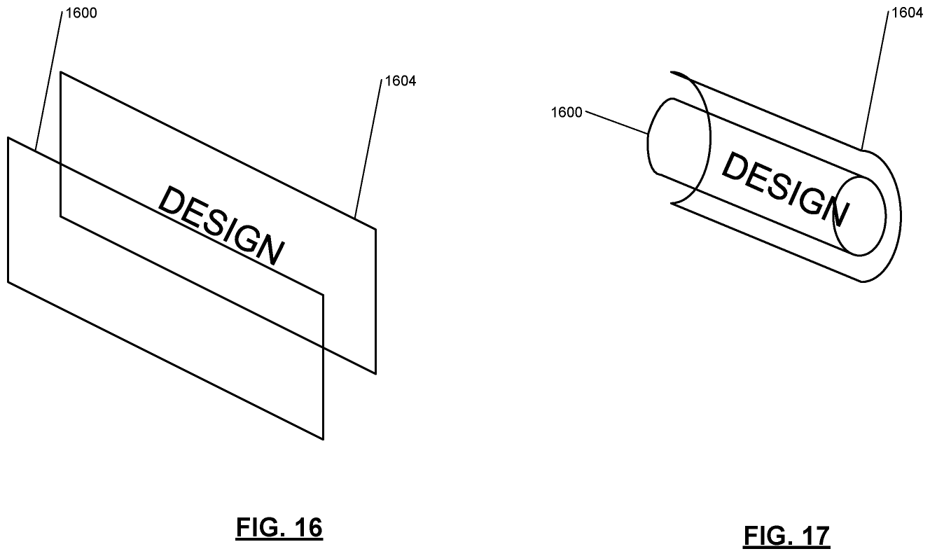

FIGS. 16 and 17 include example illustrations of a portion of a piece of sports equipment 1600 with (fluid) base paint including magnetic particles being positioned near an object 1604 with magnets located on it in the shape of the word “DESIGN”. The sports equipment 1600 may be, for example, the blade portion of a hockey stick, the hand portion of a hockey stick, a barrel or handle portion of a baseball bat, a handle portion of a lacrosse stick, or a golf club shaft.

While the example of the base paint including magnetic particles and using one or more magnets to create a design using the magnetic particles of the base paint is provided, the present application is also applicable to base paint including other types of particles that are responsive to other types of energy, such as light, sound, heat, etc.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A piece of sports equipment comprising:
a surface; and
base paint including magnetic particles, the base paint being located on the surface of the piece of sports equipment,
the magnetic particles being arranged based on a predetermined design after being subjected to magnetic field generated by one or more magnets.

2. The piece of sports equipment of claim 1 wherein the piece of sports equipment is a golf club shaft.

3. The piece of sports equipment of claim 1 wherein the piece of sports equipment is a hockey stick, and the surface is a surface of a handle portion of the hockey stick.

4. The piece of sports equipment of claim 1 wherein the piece of sports equipment is a hockey stick, and the surface is a surface of a blade portion of the hockey stick.

5. The piece of sports equipment of claim 1 wherein the piece of sports equipment is a lacrosse stick and the surface is a surface of a handle portion of the lacrosse stick.

6. The piece of sports equipment of claim 1 wherein the piece of sports equipment is a baseball bat.

7. The piece of sports equipment of claim 1 further comprising a second coat of paint applied over the base paint.

8. A method of manufacturing a piece of sports equipment, comprising:
obtaining an object including one or more magnets arranged in a predetermined design;
applying a base paint including magnetic particles to an exterior surface of the piece of sports equipment;
while the base paint is fluid, positioning the piece of sports equipment within a magnetic field of the one or more magnets; and
maintaining the positioning of the piece of sports equipment for at least a predetermined period, thereby allowing the magnetic particles in the base paint to arrange based on the predetermined design of the one or more magnets.

9. The method of claim 8 further comprising, after the maintaining the positioning of the piece of sports equipment for at least the predetermined period, curing the base paint.

10. The method of claim 8 further comprising, after the maintaining the positioning of the piece of sports equipment for at least the predetermined period, applying a second coat of paint over the base paint.

11. The method of claim 8 wherein the positioning the piece of sports equipment includes positioning the piece of sports equipment within a hollow interior of the object, wherein the one or more magnets are arranged on an interior surface of the object.

12. The method of claim 8 wherein the positioning the piece of sports equipment includes positioning the object within a hollow interior of the piece of sports equipment, wherein the one or more magnets are arranged on an exterior surface of the object.

13. The method of claim 8 wherein the positioning the piece of sports equipment includes positioning the object within a hollow interior of the piece of sports equipment, wherein the one or more magnets are arranged within the object.

14. The method of claim 13 wherein the object is made of a non-magnetic material.

15. The method of claim 8 wherein the one or more magnets include one or more rare earth magnets.

16. The method of claim 8 wherein the one or more magnets include one or more neodymium magnets.

17. The method of claim 8 wherein the positioning the piece of sports equipment includes positioning the piece of sports equipment adjacent to the object, wherein the one or more magnets are arranged on a surface of the object.

18. The method of claim 8 wherein the piece of sports equipment is a golf shaft.

19. The method of claim 8 wherein the piece of sports equipment is one of a hockey stick, a lacrosse stick, and a baseball bat.

20. The method of claim 8 wherein the magnetic particles include ferromagnetic particles.
